(19) United States
(12) Patent Application Publication
(10) Pub. No.: US 2001/0023930 A1
(43) Pub. Date: Sep. 27, 2001

(54) Electromagnetic valve

(76) Inventors: Kazuyuki Kobayashi, Anjo city (JP); Tomohiko Funahashi, Kariya city (JP); Yoshitada Katayama, Handa city (JP); Hideyuki Hayakawa, Nishio city (JP); Atsushi Yoshikawa, Kuwana city (JP)

Correspondence Address: Platon N. Mandros, BURNS, DOANE, SWECKER & MATHIS, L.L.P., P.O. Box 1404, Alexandria, VA, 22313-1404, US

(21) Appl. No.: 09/772,911

(22) Filed: Jan. 31, 2001

(30) Foreign Application Priority Data
Jan. 31, 2000 (JP) 2000-22365

(51) Int. Cl. H01F 3/00; F16K 31/02

(52) U.S. Cl. 251/129.14; 335/262

(57) ABSTRACT

The present invention is directed to an electromagnetic valve which includes a cylindrical fixed core, a spring which is mounted at a predetermined position within a hollow portion of the fixed core, a non-magnetic portion which is formed in the fixed core near the spring, and a valve seat member which is disposed at a position away from the predetermined position by a certain distance along a longitudinal axis of the fixed core. And, a movable core is disposed within the hollow portion of the fixed core between the valve seat member and the spring to be movable along the longitudinal axis of the fixed core. The movable core is provided with a stepped columnar portion having a small diameter section formed at its one end portion near the spring, and a large diameter section formed at its the other one end portion near the valve seat member, with a step formed at a boundary between the large diameter section and the small diameter section. The movable core is disposed so as to enable the step and one end portion of the small diameter section near the spring to contact with the inside wall of the hollow portion of the fixed core. And, a solenoid coil is provided for exciting the movable core and the fixed core.

This application claims priority under 35 U.S.C. Sec. 119 to No.2000-22365 filed in Japan on Jan. 31, 2000, the entire content of which is herein incorporated by reference.

### BACKGROUND OF THE INVENTION

1. Field of the Invention

The present invention relates to an electromagnetic valve, and more particularly to the electromagnetic valve, which is appropriately applicable to an apparatus for switching a flow of fluid, and which may be used for a hydraulic pressure control apparatus of an automobile, for example.

2. Description of the Related Arts

In Japanese patent Laid-open Publication No.5-164013, there is disclosed a fuel injection device which is provided with electromagnetic valves as shown in FIG. 1, and which is aimed to reduce the number of parts, so that magnetic parts such as a core, valve case and the like, which constitute a fixed core, are formed in a body, and a non-magnetization processing is applied to a portion of them to provide a non-magnetization processed portion (21). It is also disclosed in Japanese Patent Laid-open Publication No.7-189852 that a non-magnetic portion constitutes a part of a fixed core.

In Japanese Patent Laid-open Publication No.7-189852, in order to reduce a manufacturing cost of an electromagnetic actuator and reduce its size, it is proposed that a part of a circumference portion, where a fixed core and a movable core are facing each other, is constituted by an air gap or a non-magnetic member. Consequently, it is described that even if the position of the non-magnetic portion in the fixed core is shifted, magnetic flux is prevented from being leaked from the cicumferential surface of the movable core. Furthermore, it is described that wear on a sliding surface can be reduced by using the non-magnetic member to work as the sliding surface for the movable core.

However, when a complex magnetic member with the magnetic member and non-magnetic member formed in a body, as shown in the above Publications, is employed as the fixed core, a biasing force applied laterally to the movable core will be enlarged. Therefore, when the movable core slides on an inside wall of the hollow portion of the fixed core, a large frictional force will be generated to cause a bar to a returning operation of the movable core. Furthermore, when a valve member is seated on a valve seat, it might be displaced from the seat.

FIG. 4 illustrates operating states of an electromagnetic valve generally known in the prior art, wherein a movable core 40 is accommodated in a hollow fixed core 10, and a non-magnetic member 11 as described in the above publications is formed in the vicinity of an upper end surface 12 of the hollow portion of each fixed core 10. According to the electromagnetic valve as described above, when a solenoid coil (not shown) is excited (energized), an attracted surface of the movable core 40 at an upper end thereof is attracted to an upper end surface 12 of the hollow portion of each fixed core 10, and at the same time an outside wall of the movable core 40 is attracted to an inside wall 13 of the hollow portion of the fixed core 10. As a result, a valve member V is moved away from a valve seat 30. Next, when the excitation of the solenoid coil is terminated, the movable core 40 is driven by a biasing force of a spring 20 toward the valve seat 30, while the movable core 40 slides on the inside wall 13 of the hollow portion of the fixed core 10, with the outside wall of a columnar portion of the movable core 40 being in tight contact with the inside wall 13. When the movable core 40 is moved further toward the valve seat 30, and positioned in such a state that the valve member V is moved along an inclined surface of the valve seat 30 as shown in FIG. 4(c), a lower end of the columnar portion of the movable core 40 is moved away from the inside wall 13 of the hollow portion of the fixed core 10. Then, the valve member V is seated on the valve seat 30 to be in its closed state as shown in FIG. 4(d).

As described above, when the excitation of the solenoid coil is terminated in the state as shown in FIG. 4(a), the movable core 40 slides on the inside wall 13 of the hollow portion of the fixed core 10, with the columnar portion of the movable core 40 being in tight contact with the inside wall 13 of the hollow portion of the fixed core 10, from the state as shown in FIG. 4(b) to the state as shown in FIG. 4(d). Therefore, when the movable core 40 slides on the inside wall 13, a large frictional force is generated to cause various problems, such as a problem for causing a delay in returning operation of the movable core 40 and the valve member V.

In order to solve the above problems, it is a general solution to ensure an ability to be seated on the valve seat 30 by increasing the biasing force of the spring 20. In order to produce a necessary attracting force, however, it is necessary to enlarge the electromagnetic force against a requirement for reducing its size. And, in the case where the valve member V is seated on the valve seat 30, after the valve member V abuts on a position offset from the center of the valve seat 30, it moves toward the center, sliding in such a state as it is pressed in the longitudinal axis. As a result, the valve seat 30 will be worn in part, thereby to reduce its durability.

### SUMMARY OF THE INVENTION

Accordingly, it is an object of the present invention to reduce in size an electromagnetic valve, more particularly to provide the electromagnetic valve, which can drive a movable core appropriately, even if it is provided with a non-magnetic portion formed in a fixed core.

In accomplish the above and other objects, the present invention is directed to an electromagnetic valve which includes a cylindrical fixed core, a biasing member mounted at a predetermined position within a hollow portion of the fixed core, a non-magnetic portion formed in the fixed core near the biasing member, and a valve seat member disposed at a position away from the predetermined position by a certain distance along a longitudinal axis of the fixed core. And, a movable core is disposed within the hollow portion of the fixed core between the valve seat member and the biasing member to be movable along the longitudinal axis of the fixed core. The movable core is provided with a stepped columnar portion having a small diameter section formed at one end portion of the stepped columnar portion near the biasing member, and a large diameter section formed at the other one end portion of the stepped columnar portion near the valve seat member, with a step formed at a boundary between the large diameter section and the small diameter section. The movable core is disposed so as to enable the step of the stepped columnar portion and one end portion of the small diameter section near the biasing member to contact with the inside wall of the hollow portion of the fixed core. And, a solenoid coil is provided for exciting the movable core and the fixed core.

According to the above-described electromagnetic valve, therefore, the movable core can be easily returned to its original position, when the excitation of the solenoid coil is terminated.

Preferably, the electromagnetic valve may further comprise a spherical valve member which is fixed to the one end of the movable core facing the valve seat member to be seated on the valve seat member. The movable core is placed so that the spherical valve member is biased toward the center of the valve seat member, in such a state that the step of the stepped columnar portion and the one end portion of the small diameter section near the biasing member are in contact with the inside wall of the hollow portion of the fixed core. As a result, a good durability of the valve seat member can be obtained without causing a partial wear of the valve seat member.

### BRIEF DESCRIPTION OF THE DRAWINGS

The above stated objects and following description will become readily apparent with reference to the accompanying drawings, wherein like reference numerals denote like elements, and in which:

FIG. 1 is a sectional view of an electromagnetic valve according to an embodiment of the present invention;

FIG. 2 is a sectional view of a movable core according to an embodiment of the present invention;

FIG. 3 is a series of sectional views of electromagnetic valves in operation according to an embodiment of the present invention; and

FIG. 4 is a series of sectional views of electromagnetic valves in operation according to a prior art.

### DESCRIPTION OF THE PREFERRED EMBODIMENT

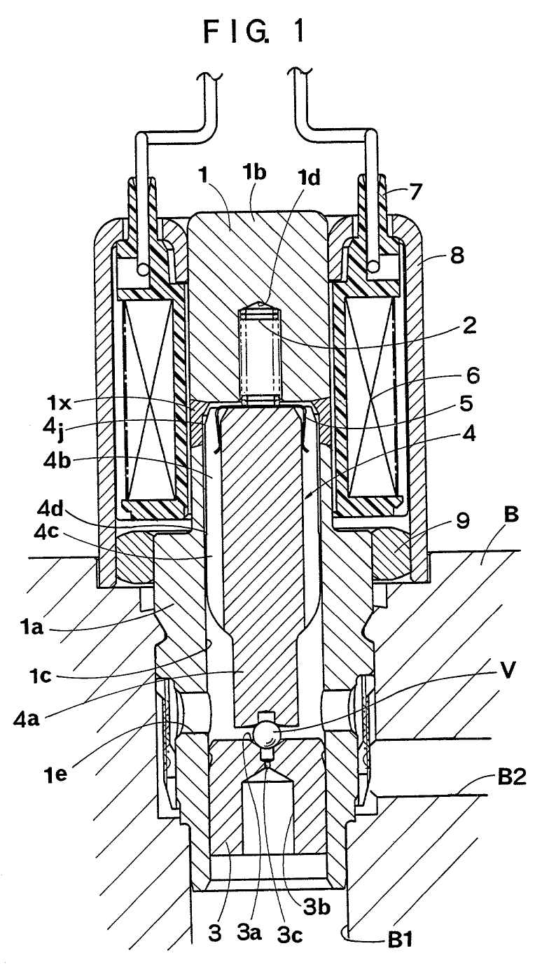

Referring to FIG. 1, there is disclosed an electromagnetic valve according to an embodiment of the present invention, wherein a fixed core 1 of a cylinder with a bottom is secured to a block B for controlling hydraulic braking pressure. The fixed core 1 includes a magnetic portion 1a formed in the shape of a cylinder, a magnetic portion 1b formed in the shape of a column, and a non-magnetic portion 1x disposed between the magnetic portions 1a and 1b to be formed in a body. The magnetic portion 1b is formed with a recess 1d, which is formed along its central axis, and opened in a hollow portion 1c of the magnetic portion 1a. A helical compression spring 2 (hereinafter, simply referred to as a spring 2) is accommodated in the recess 1d, so as to act as a biasing member according to the present invention. The magnetic portion 1a of the fixed core 1 is formed, in a radial direction thereof, with a communication hole 1e, through which the hollow portion 1c is adapted to communicate with a fluid passage B2 of the block B.

In the vicinity of the opening end portion of the fixed core 1, fitted is a valve seat member 3 that is formed in the shape of a cylinder with a bottom, on one end surface of which a valve seat 3a is formed. An orifice 3c is formed between the valve seat 3a and a hollow portion 3b to communicate them through the orifice 3c. When a spherical valve member V as described hereinafter is seated on the valve seat 3a, the orifice 3c is closed, whereas when the valve member V is moved away from the valve seat 3a, then the fluid passage B2 of the block B is communicated with the fluid passage B1 through the hole 1e, the hollow portion 1c of the fixed core 1, orifice 3c, and the hollow portion 3b of the valve seat member 3.

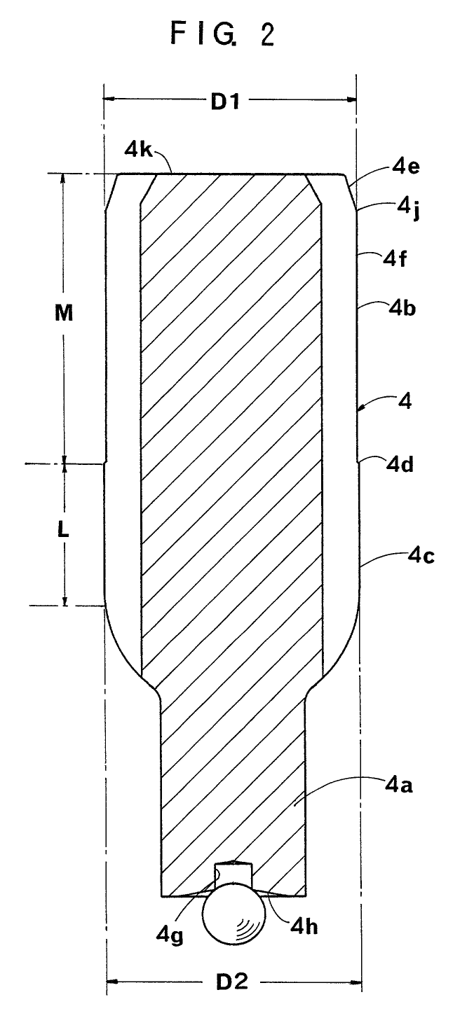

Within the hollow portion 1c of the fixed core 1, a movable core 4 is accommodated, and biased by the spring 2 toward the valve seat 3 to be movable along its longitudinal axis. As enlarged in FIG. 2, the movable core 4 is reduced in diameter to form a plunger portion 4a at its one end portion near the valve seat member 3. A hole 4g is formed in the center of the tip end surface of the plunger portion 4a, and a conical recess 4h is formed around the hole 4g. The spherical valve member V is fixed to the recess 4h by welding, and disposed to be seated on the valve seat 3a as shown in FIG. 1.

As shown in FIG. 2, a section having a longitudinal length M located at an upper portion (at the side near the spring 2) of the movable core 4 is formed to provide a small diameter section 4b having a diameter D1, while a section having a longitudinal length L located between the small diameter section 4b and the plunger portion 4a is formed to provide a large diameter section 4c having a diameter D2. That is, an annular step 4d is formed at the boundary between the small diameter section 4b and the large diameter section 4c, which constitute a stepped columnar portion according to the present invention. The upper end portion of the movable core 4 is reduced in diameter to form a reduced diameter portion 4e and an annular edge 4j. On the outside wall of the movable core 4, a pair of grooves 4f are formed along its longitudinal axis, and a shim 5 is fitted into the grooves 4f at the upper most end thereof (at the side near the spring 2) as shown in FIG. 1, to provide a certain nonmagnetic gap when the movable core 4 is attracted to the magnetic portion 1b of the fixed core 1. The movable core 4 is disposed so as to enable the step 4d and the edge 4j to contact with the inside wall of the hollow portion 1c of the fixed core 1. And, a solenoid coil 6 for exciting the movable core 4 and the fixed core 1 are provided as shown in FIG. 1. The solenoid coil 6 are wound around a bobbin 7, and fixed inside of a cylindrical case 8, and further a metallic ring 9 is fixed inside of an open end of the case 8, to provide a cylindrical subassembly, which is fitted into the hollow portion of the bobbin 7.

When electric current is fed to the solenoid coil 6, a magnetic circuit is formed by the magnetic portion 1a of the fixed core 1, movable core 4, magnetic portion 1b of the fixed core 1, case 8 and ring 9, so that the movable core 4 is attracted toward the magnetic portion 1b of the fixed core 1 against the biasing force of the spring 2, to force the valve member V be placed away from the valve seat 3a. When the electric current is prevented from being fed to the solenoid coil 6, the movable core 4 is driven downward (toward the valve seat 3a) to seat the valve member V on the valve seat 3a. In this returning operation, the movable core 4 is adapted to be slidable, with two positions of the step 4d and the edge 4j of the small diameter section 4b (i.e., the boundary between the small diameter section 4b and the reduced diameter portion 4e) forced to be in contact with the inside wall of the hollow portion 1c of the fixed core 1.

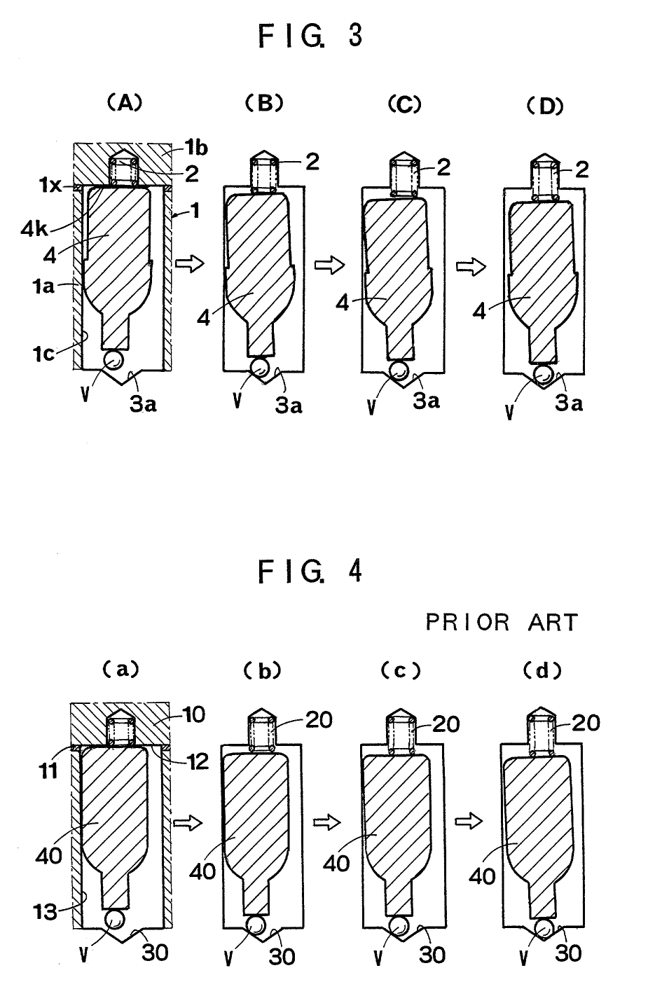

The electromagnetic valve as constituted above operates as explained hereinafter with reference to FIGS. 1 and 3. Once the electric current is fed to the solenoid coil 6, an attracted surface 4k at the uppermost end of the movable core 4 is attracted to the magnetic portion 1b of the fixed core 1, and the large diameter section 4c of the movable core 4 is attracted to the inside wall of the hollow portion 1c of the fixed core 1, as shown in FIG. 3(A). Consequently, the valve member V is moved away from the valve seat 3a, so that the passage B1 and the passage B2 (in FIG. 1) are communicated with each other. In this case, a space is formed between the small diameter section 4b and the inside wall of the hollow portion 1c. According to the present embodiment, since the small diameter section 4b is formed at the upper portion (at the side near the spring 2) of the movable core 4, the influence to the magnetic circuit caused by the space is small, so that it can prevent the attracting force from being reduced.

Next, when the electric current is stopped from being fed to the solenoid coil 6, the movable core 4 is moved toward the valve seat member 3 by the biasing force of the spring 2, as shown in FIG. 3(B). In this case, the small diameter section 4b is in contact with the inside wall of the hollow portion 1c of the fixed core 1 at two positions of the step 4d and the edge 4j, and the valve member V is in a tilted state, directing toward the center of the valve seat 3a, so that the valve member V moves toward the valve seat 3a smoothly and certainly. Accordingly, the valve member V abuts on the valve seat 3a as shown in FIG. 3(B), and a partial wear that may be caused when the valve member V moves on the tilted surface of the valve seat 3a as shown in FIG. 3(C) will be reduced to improve its durability, comparing with the prior art. In this case, the step 4d (i.e., the largest diameter portion) of the movable core 4 is apart from the inside wall of the hollow portion 1c of the fixed core 1.

Thus, when the valve member V moves on the tilted surface of the valve seat 3a, the contacting area of the movable core 4 to be in contact with the inside wall of the hollow portion 1c of the fixed core 1 becomes the sum of the contacting area of the step 4d and that of the edge 4j, or only the contacting area of the edge 4j, so that the contacting area is largely reduced, comparing with that of the prior art. Consequently, the sliding resistance will be reduced, and the valve member V will be hardly affected by a remnant magnetism, so that a smooth returning operation of the valve member V can be ensured. When the valve member V is seated on the valve seat 3a as shown in FIG. 3(D), the communication between the fluid passage B1 and the fluid passage B2 is blocked to be in its closed state.

As shown in FIG. 2, the height of the step 4d (i.e., stepped difference) is (D2−D1)/2. In terms of the returning operation of the movable core 4, it is preferable that the height of the step 4d is set to be as large as possible, and the length (L) of the large diameter section 4c is set to be as short as possible. In order to avoid reduction of the attracting force when the valve is to be opened, however, the diameter D1 of the small diameter section 4b forming the stepped difference is set to be of a value within such a range that the area substantially attracted to the inside wall of the hollow portion 1c of the fixed core 1 will not be reduced. And, the length (L) of the large diameter section 4c is set be of a value within such a range that the magnetic circuit between the large diameter section 4c and the inside wall of the fixed core 1 will not be badly affected.

Furthermore, the stepped difference and the length (M) of the small diameter section 4b are set to reduce the offset from an axis for connecting the center of the valve member V with the center of the valve seat 3a, as small as possible, when the movable core 4 is in contact with the inside wall of the hollow portion 1c of the fixed core 1 at the two positions as described before. That is, not only in the case where the movable core 4 does not contact with the inside wall of the hollow portion 1c of the fixed core 1, but also in the case where the step 4d and the edge 4j of the small diameter section 4c are in contact with the inside wall of the hollow portion 1c of the fixed core 1, the movable core 4 is arranged so that the valve member V is biased toward the center of the valve seat 3a by means of the biasing force of the spring 2.

It should be apparent to one skilled in the art that the above-described embodiment is merely illustrative of but one of the many possible specific embodiments of the present invention. Numerous and various other arrangements can be readily devised by those skilled in the art without departing from the spirit and scope of the invention as defined in the following claims.

What is claimed is:

1. An electromagnetic valve comprising:
a cylindrical fixed core;
a biasing member mounted at a predetermined position within a hollow portion of the fixed core;
a non-magnetic portion formed in the fixed core near the biasing member;
a valve seat member disposed at a position away from the predetermined position by a certain distance along a longitudinal axis of the fixed core;
a movable core disposed within the hollow portion of the fixed core between the valve seat member and the biasing member to be movable along the longitudinal axis of the fixed core, the movable core being provided with a stepped columnar portion having a small diameter section formed at one end portion of the stepped columnar portion near the biasing member, and a large diameter section formed at the other one end portion of the stepped columnar portion near the valve seat member, with a step formed at a boundary between the large diameter section and the small diameter section, and the movable core being disposed so as to enable the step of the stepped columnar portion and one end portion of the small diameter section near the biasing member to contact with an inside wall of the hollow portion of the fixed core; and
a solenoid coil for exciting the movable core and the fixed core.

2. The electromagnetic valve of claim 1, further comprising a spherical valve member fixed to one end of the movable core facing the valve seat member to be seated on the valve seat member, wherein the movable core is placed so that the spherical valve member is biased toward the center of the valve seat member, in such a state that the step of the stepped columnar portion and the one end portion of the small diameter section near the biasing member are in contact with the inside wall of the hollow portion of the fixed core.

3. The electromagnetic valve of claim 2, wherein the one end portion of the small diameter section near the biasing member is reduced in diameter to form an annular edge on the small diameter section, and wherein the movable core is disposed so as to enable the step and the edge to contact with the inside wall of the hollow portion of the fixed core.

4. The electromagnetic valve of claim 3, wherein the annular edge is formed on the small diameter section at a position thereof facing with the non-magnetic portion formed in the fixed core.

5. The electromagnetic valve of claim 1, wherein a pair of grooves are formed on the outside wall of the movable core along the longitudinal axis thereof.

6. The electromagnetic valve of claim 1, wherein the biasing member is a helical compression spring received in the hollow portion of the fixed core.
